(19) United States
(12) Patent Application Publication
(10) Pub. No.: US 2007/0223615 A1
(43) Pub. Date: Sep. 27, 2007

(54) Transceiver interface architecture

(76) Inventors: Sathwant Dosanjh, Toronto (CA); Tajinder Manku, Waterloo (CA); Alan Holden, McKinney, TX (US)

Correspondence Address: BORDEN LADNER GERVAIS LLP, 1100-100 QUEEN ST, OTTAWA, ON, K1P 1J9, CA

(21) Appl. No.: 11/387,925

(22) Filed: Mar. 24, 2006

(51) Int. Cl. H04L 1/02; H04B 1/00

(52) U.S. Cl. 375/267; 375/141

(57) ABSTRACT

A transceiver interface architecture where the same RF transceiver can be used in wireless devices that support any number of standards, with or without receive diversity implementation. Each input port of the RF transceiver can be shared by a number of input signals, which effectively expands the number of available input ports. Input port sharing can be realized with virtual ports that receive two or more input signals and selectively pass one signal to the physical input port. The use of virtual ports allows for flexible wireless design implementations using the same RF transceiver, and in particular, for receive diversity implementations that inherently require dedicated input ports. The use of low cost and small area virtual ports obviates the need for larger and more costly RF receivers.

### FIELD OF THE INVENTION

The present invention relates generally to multi-band radio system architectures. More particularly, the present invention relates to radio system architectures for supporting multiple band receive diversity.

### BACKGROUND OF THE INVENTION

Technological advances over the last several years have enabled manufacturers to develop smaller and more portable devices, rich in features and miserly on power consumption. Cellular phones and wireless enabled personal digital assistants (PDA's) are examples of such devices, which are now pervasive in modem society due to their portability and convenience, making wireless telecommunication a ubiquitous means for transferring information between users.

While voice communication has been the primary use of cellular phones, mainly due to transmission rate limitations, communication standards have emerged which enable higher bandwidth applications. Such applications include viewing streamed video such as television programming, and real-time Internet browsing capabilities. Two main communication standards are in use today, which can support both voice and data communication; GSM (global system for mobile communications) and WCDMA (wideband code division multiple access), both of which are multi-band.

Preferably, a wireless device is multi-standard compliant such that the single device can be used virtually anywhere regardless of the type of standard that is predominantly used. Otherwise, the user would need to carry at least two different wireless devices, each dedicated to operating with a specific telecommunication standard. Therefore, a multi-standard compliant device is highly desired.

FIG. 1 is a block diagram illustrating the general architecture of a wireless device, such as cellular phone for example. Three major components of the wireless device 10 are shown in FIG. 1. First is the digital base-band processor 12, which is responsible for processing receive and transmit data of the wireless device 10. Second is the RF transceiver 14 which is responsible for up-conversion of wireless data provided by the base-band processor 12 to a particular standard and frequency, and for down-conversion of received wireless data from a particular standard and frequency to the base-band processor 12. RF transceiver chips are available from companies such as Sirific Wireless Corporation. Third is the SP9T antenna switch 16 that shares the single antenna 18 with the various input/output paths of the RF transceiver 14, each of which can have dedicated use of the antenna 18. SP9T antenna switch 16 is a commercially available single pole nine throw component designed specifically for antenna switching, as will be described later.

Other components of wireless device 10 include the GSM/EDGE (enhanced data for global evolution) front end block 20 and the WCDMA front end block 22. Both blocks 20 and 22 include standard and well known receive and transmit path circuits. It is noted that the details of GSM front end block 20 and WCDMA front end block 22 are not shown, since FIG. 1 is intended to illustrate the signal path from antenna 18 to RF transceiver 14. It is noted that the signals received and provided by RF transceiver 14 are often differential in nature, but are shown as single-ended signals to simplify the schematic.

In the presently shown example of FIG. 1, RF transceiver 14 is configured for operating in quad-band GSM (850/900/DCS/PCS) and tri-band WCDMA (IMTIPCS/850) standards. RF transceiver 14 is configured to include at total of 12 dedicated input/output ports. The first four input ports IN1 to IN4 are each dedicated for receiving the GSM 850, GSM 900, GSM DCS and GSM PCS band wireless transmission signals, while two output ports OUT1 and OUT2 are each dedicated for transmitting GSM high and low band signals. The last three input ports IN5 to IN7 are each dedicated for receiving WCDMA 850, WCDMA PCS and WCDMA IMT band wireless transmission signals, while the last three output ports OUT3 to OUT5 are each dedicated for transmitting the same respective band signals. As should be known by those skilled in the art, each input port is typically configured for receiving signals within a predetermined frequency range. Hence, depending on the selected communication standard being used, the appropriate input/output ports will be enabled. For example, if the wireless device 10 is to receive transmissions in the GSM 900 standard, then only input port IN2 will receive the signal.

While not shown, WCDMA front end block 22 includes duplexers for selectively connecting the three bidirectional lines 24 to either the respective input ports (IN5 to IN7) or output ports (OUT3 to OUT5).

As can be seen in FIG. 1, there is a one to one ratio of RF transmitter 14 ports to signal paths from antenna switch 16. The RF transmitter 14 in the present example is configured to accommodate the multiple GSM and WCDMA bands, meaning that it has been designed and manufactured with a limited number of input/output ports. Although the same RF transceiver 14 can be used in wireless devices that support fewer bands, it cannot be used to support a number of bands and/or standards that is greater than what it was manufactured for. More significantly, the wireless device configuration of FIG. 1 cannot support diversity operation without additional components.

Diversity, more specifically receive diversity, is a function where a signal can be received by the wireless device from two antennas in parallel. This feature is typically used to achieve higher data rates in areas where signal strength is not optimal, and processing of both received signals by the base-band processor can effectively improve receive performance. In an environment with large buildings for example, a signal received by the primary antenna may be sub-optimal due to interference from reflections. The signal received by the secondary antenna can be processed by the base-band processor using various algorithms to effectively combine and optimize the overall received signal. Because the RF transceiver is typically multi-standard and multi-band compliant, receive diversity for as many of these standards and bands should be supported as well. As will be shown in FIG. 2, receive diversity for multi-standard multi-band RF transceivers is not efficiently implemented in wireless devices.

FIG. 2 shows a block diagram of a wireless device similar to that shown in FIG. 1, but now configured for receive diversity support. Wireless device 50 uses the same components as in wireless device 10, namely RF transceiver 14, antenna switch 16 with antenna 18, GSM/EDGE front end block 20, and WCDMA front end block 22. As for the wireless device 10 of FIG. 2, wireless device 50 can support quad-band GSM (850/900/DCS/PCS) and tri-band WCDMA (IMT/PCS/850) standards. To enable receive diversity for the all three WCDMA bands, an additional receive path must be implemented. In FIG. 2, this additional receive path includes a second antenna 52, a SP3T antenna switch 54, a WCDMA receive front-end block 56, and a WCDMA receiver 58. All signals are shown in their respective formats, ie. single or differential.

In order to support all three WCDMA bands, three receive sub-paths (for IMT/PCS/850) are required. Accordingly, the SP3T antenna switch will selectively couple the second antenna 52 to one of the three sub-paths connected to WCDMA receive front end block 56. The WCDMA receive front end block 56 includes most of the same receive circuits that are used in WCDMA front end block 22, and converts the single ended input signals into respective differential signals. The WCDMA receiver 58 performs the same receive functionality as RF transceiver 14, but is dedicated to receiving the WCDMA 850, WCDMA PCS and WCDMA IMT signals at its input ports IN1, IN2 and IN3 respectively. WCDMA receiver 58 then interfaces with digital base-band processor to provide the received data for further processing.

The primary disadvantage of wireless device 50 is the requirement of WCDMA receiver 58. As previously noted, RF transceiver 14 does not have a single spare input port, let alone three spare input ports, for receiving the additional three WCDMA bands. WCDMA receiver 58 is a relatively large component that uses precious board space, which can restrict the overall form factor and size of the final product. Furthermore, the cost of WCDMA receiver 58 can be in the range of dollars/device, which is a significant cost overhead for implementing wireless device 50. Therefore, adding WCDMA receiver 58 is a significant premium for implementing receive diversity. Because the additional WCDMA receiver 58 is required, the baseband processor 102 must have the capability to interface with both the RF transceiver 104 and WCDMA receiver 58. This adds complexity and may place restrictions on the type of baseband processor which can be used.

Of course, wireless device 50 can be implemented in a configuration where WCDMA receiver 58 is not required. However, this would require a replacement for RF transceiver 14 which has the capability to receive the additional receive sub-paths for supporting tri-band receive diversity. More specifically for wireless device 50, RF transceiver 24 would need to be replaced with a different RF transceiver having an additional three input ports for receiving the WCDMA 850, WCDMA PCS and WCDMA IMT signals provided by WCDMA receive front end block 56. Unfortunately, this solution would be more costly since two different RF transceivers would need to be manufactured; one for non-diversity wireless devices and one for diversity enabled wireless devices. Those skilled in the art will understand that flexible use of a single chip for multiple applications, ie. non-diversity and diversity implementations is far more cost effective.

Alternately, a single RF transceiver having numerous input ports to anticipate future expansion can be used. Unfortunately, such an RF transceiver will still have a finite number of input ports, which may be insufficient for unforeseen future expansion. Furthermore, there is a practical limitation to the number of input ports and associated circuits, which can be implemented on an RF transceiver. Too many unused input ports will waste silicon area and ultimately add to the RF transceiver cost.

It is, therefore, desirable to provide a wireless device architecture, which can efficiently use the same RF transceiver for any number of standards and bands in diversity and non-diversity applications.

### SUMMARY OF THE INVENTION

It is an object of the present invention to obviate or mitigate at least one disadvantage of previous RF transceiver interface architectures. In particular, it is an object of the invention to provide a flexible RF transceiver receive interface for sharing a physical input port with at least two input signals.

In a first aspect, the present invention provides a signal interface circuit for a receiving component. The signal interface circuit includes filter means and a switch circuit. The filter means receives a first wireless transmission signal and a second wireless transmission signal for providing corresponding first and second wireless transmission signal outputs. The switch circuit receives the first and the second wireless transmission signal outputs for providing a differential output signal corresponding to one of the first and second wireless transmission signal outputs.

According to an embodiment of the present aspect, the filter means includes a first differential output SAW filter and a second differential output SAW filter. The first differential output SAW filter receives the first wireless transmission signal and provides a first differential output signal corresponding to the first wireless transmission signal output. The second differential output SAW filter receives the second wireless transmission signal and provides a second differential output signal corresponding to the second wireless transmission signal output. The switch circuit includes a first 2:1 RF switch circuit and a second 2:1 RF switch circuit. The first 2:1 RF switch circuit receives first phases of the first differential output signal and the second differential output signal, and selectively passes one of the first phases. The second 2:1 RF switch circuit receives second phases of the first differential output signal and the second differential output signal, and selectively passes one of the second phases, where the differential output signal corresponding to the passed first and second phases.

According to another embodiment of the present aspect, the filter means includes a first single-ended output SAW filter and a second single-ended output SAW filter. The first single-ended output SAW filter receives the first wireless transmission signal and provides a first single-ended output signal corresponding to the first wireless transmission signal output. The second single-ended output SAW filter receives the second wireless transmission signal and provides a second single-ended output signal corresponding to the second wireless transmission signal output. The switch circuit includes a 2:1 RF switch circuit for receiving the first and the second single-ended output signals and for selectively passing one of the first and the second single-ended output signals to a balun, where the balun provides the differential output signal.

In a second aspect, the present invention provides a multi-standard compliant wireless device for receiving first and second transmission signals. The wireless device inlcudes a signal interface circuit, and an RF transceiver. The signal interface circuit receives the first and the second transmission signals and selectively passes one of the first and the second transmission signals as a selected input transmission signal. The RF transceiver has first and second input ports each configured for receiving either the first or the second transmission signals, the RF transceiver receiving the selected input transmission signal at the first input port.

In an embodiment of the second aspect, the first and the second transmission signals are provided by an antenna switch coupled to an antenna, and the signal interface circuit includes filter means and a switch circuit. The filter means for receiving the first transmission signal and the second transmission signal, the filter means provides corresponding first and second transmission signal outputs. The switch circuit receives the first and the second transmission signal outputs and provides a differential output signal corresponding to one of the first and second transmission signal outputs.

According to an aspect of the present embodiment, the filter means includes a first differential output SAW filter and a second differential output SAW filter. The first differential output SAW filter receives the first transmission signal and provides a first differential output signal corresponding to the first transmission signal output. The second differential output SAW filter receives the second transmission signal and provides a second differential output signal corresponding to the second transmission signal output. The switch circuit indudes a first 2:1 RF switch circuit and a second 2:1 RF switch circuit. The first 2:1 RF switch circuit receives first phases of the first differential output signal and the second differential output signal, and selectively passes one of the first phases. The second 2:1 RF switch circuit receiving second phases of the first differential output signal and the second differential output signal, and selectively passes one of the second phases, the differential output signal corresponding to the passed first and second phases.

In a further embodiment of the present aspect, the filter means includes a first single-ended output SAW filter and a second single-ended output SAW filter. The first single-ended output SAW filter receives the first transmission signal and provides a first single-ended output signal corresponding to the first transmission signal output. The second single-ended output SAW filter receives the second transmission signal and provides a second single-ended output signal corresponding to the second transmission signal output. The switch circuit includes a 2:1 RF switch circuit for receiving the first and the second single-ended output signals and for selectively passing one of the first and the second single-ended output signals to a balun, the balun providing the differential output signal.

In yet another embodiment, the switch circuit includes a 2:1 integrated differential RF switch circuit for receiving the first differential output signal and the second differential output signal, the differential RF switch circuit selectively passing one of the first differential output signal and the second differential output signal as the differential output signal.

In another embodiment, the multi-standard compliant wireless device further includes a receive diversity circuit for providing a receive diversity signal to the second input port. The receive diversity circuit includes a second signal interface circuit for receiving a first diversity signal and a second diversity signal, and selectively passes one of the first diversity signal and the second diversity signal as the receive diversity signal. The receive diversity circuit includes a second antenna switch coupled to a second antenna for providing the first diversity signal and the second diversity signal. The second signal interface circuit includes filter means and a switch circuit. The filter means receives the first diversity signal and the second diversity signal, and provides corresponding first and second diversity signal outputs. The switch circuit receives the first and the second diversity signal outputs and provides the receive diversity signal corresponding to one of the first and second diversity signal outputs. The filter means includes a first differential output SAW filter and a second differential output SAW filter. The first differential output SAW filter receives the first diversity signal and provides a first differential output signal corresponding to the first diversity signal output. The second differential output SAW filter receives the second diversity signal and provides a second differential output signal corresponding to the second diversity signal output.

In aspects of the present embodiment, the switch circuit includes a first 2:1 RF switch circuit and a second 2:1 RF switch circuit. The first 2:1 RF switch circuit receives first phases of the first differential output signal and the second differential output signal, and selectively passes one of the first phases. The second 2:1 RF switch circuit receives second phases of the first differential output signal and the second differential output signal, and selectively passes one of the second phases, where the differential output signal corresponding to the passed first and second phases. The filter means includes a first single-ended output SAW filter for receiving the first diversity signal and for providing a first single-ended output signal corresponding to the first diversity signal output, and a second single-ended output SAW filter for receiving the second diversity signal and for providing a second single-ended output signal corresponding to the second diversity signal output. The switch circuit includes a 2:1 RF switch circuit for receiving the first and the second single-ended output signals and for selectively passing one of the first and the second single-ended output signals to a balun, where the balun providing the differential output signal. Alternately, the switch circuit includes a 2:1 integrated differential RF switch circuit for receiving the first differential output signal and the second differential output signal, the differential RF switch circuit selectively passing one of the first differential output signal and the second differential output signal as the receive diversity signal.

According to a further embodiment of the present aspect, the second signal interface circuit receives a third diversity signal, and selectively passes one of the first diversity signal, the second diversity signal and the third diversity signal. The filter means includes a first differential output SAW filter, a second differential output SAW filter and a third differential output SAW filter. The first differential output SAW filter receives the first diversity signal and provides a first differential output signal corresponding to the first diversity signal output. The second differential output SAW filter receives the second diversity signal and provides a second differential output signal corresponding to the second diversity signal output. The third differential output SAW filter receives the third diversity signal and provides a third differential output signal. The switch circuit includes a 3:1 integrated differential RF switch circuit for receiving the first differential output signal, the second differential output signal and the third differential output signal. The 3:1 integrated differential RF switch circuit selectively passing one of the first differential output signal, the second differential output signal and the third differential output signal as the receive diversity signal.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a wireless device without receive diversity;

FIG. 2 is a prior art receive diversity implementation of the wireless device of FIG. 1;

FIG. 3 is a block diagram illustrating a wireless device architecture according to an embodiment of the present invention;

FIG. 4 is an implementation example of the wireless device architecture of FIG. 3, according to an embodiment of the present invention;

FIG. 5 is an illustration of an antenna switch application according to the prior art;

FIG. 6 is a block diagram of a 2:1 differential signal switching circuit, according to an embodiment of the present invention;

FIG. 7 is a block diagram of a 2:1 single-ended switching circuit, according to an embodiment of the present invention;

FIG. 8 is a block diagram of a 2:1 integrated differential signal switching circuit, according to an embodiment of the present invention;

FIG. 9 is a block diagram of a 3:1 differential signal switching circuit, according to an embodiment of the present invention; and,

FIG. 10 is a block diagram of a 3:1 integrated differential signal switching circuit, according to an embodiment of the present invention.

### DETAILED DESCRIPTION

Generally, the present invention provides a transceiver interface architecture where the same RF transceiver can be used in wireless devices that support any number of standards and bands, with or without receive diversity implementation. Each input port of the RF transceiver is preferably wide-band in nature and has the correct frequency selectivity, can be shared by a number of input signals, which effectively expands the number of available input ports. Input port sharing can be realized with virtual ports that receive two or more input signals and selectively pass one signal to the physical input port. The use of virtual ports allows for flexible wireless design implementations using the same RF transceiver, and in particular, for receive diversity implementations that inherently require dedicated input ports. The use of low cost and small area virtual ports obviates the need for larger, dedicated, and more costly RF receivers.

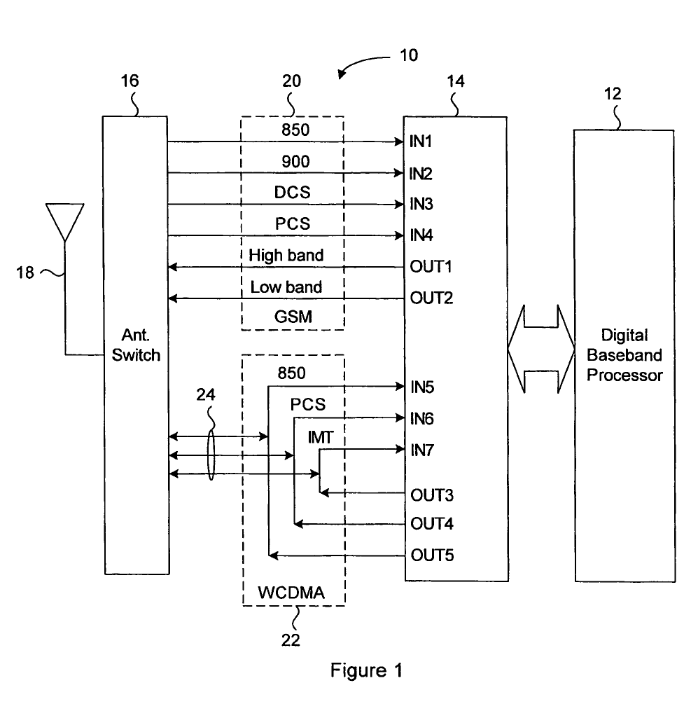

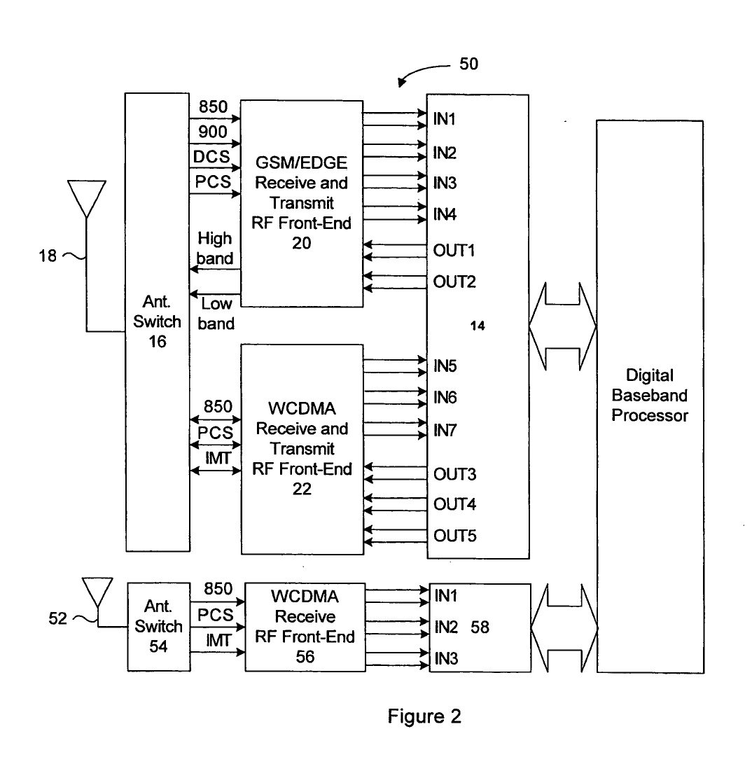

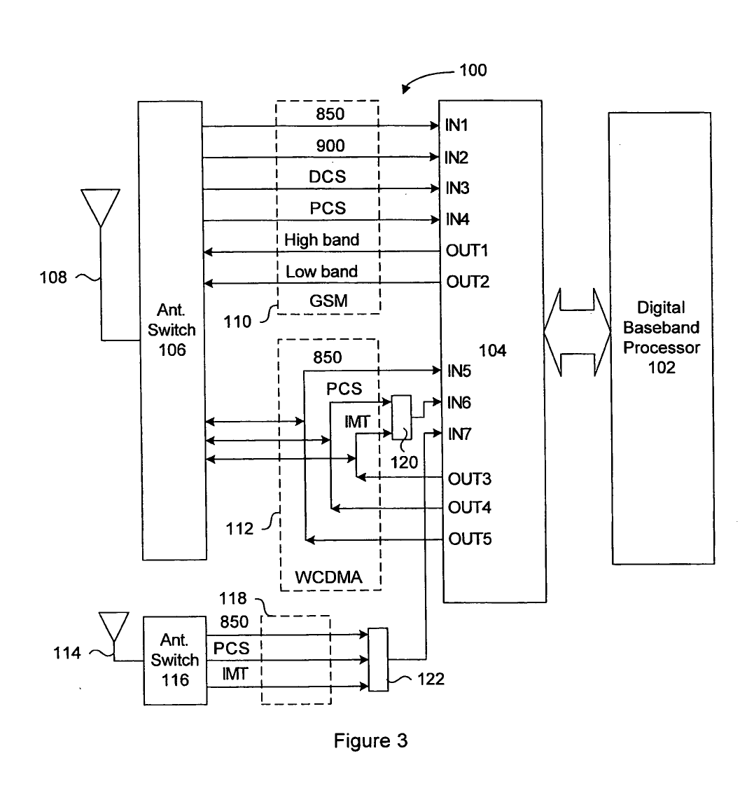

FIG. 3 is a block diagram of a wireless device architecture according to an embodiment of the present invention. Once again, details are not shown to better illustrate the signal paths. The presently shown wireless device 100 supports quad-band GSM (850/900/DCS/PCS) and tri-band WCDMA (IMT/PCS/850) operation, with tri-band WCDMA (IMT/PCS/850) receive diversity. Wireless device 100 includes substantially the same components as wireless device 10 in FIG. 1. Digital base-band processor 102, RF transceiver 104, SP9T antenna switch 106, antenna 108, GSM/EDGE front end block 110 and WCDMA front end block 112 can be the same as circuit blocks 12, 14, 16, 18, 20 and 22 respectively in FIG. 1. RF transceiver 104 can be provided by Sirific Wireless Limited. To implement receive diversity, a receive diversity circuit is included. The receive diversity circuit includes secondary antenna 114, SP3T antenna switch 116 and WCDMA receive front end block 118, which can be the same as circuit blocks 52, 54 and 56 respectively.

In this present example, RF transceiver 104 has seven input ports, which is typical for a quad-band GSM and tri-band WCDMA implementation. In order to accommodate diversity, a 2:1 virtual port 120 is inserted between input port IN6 and the WCDMA PCS and WCDMA IMT signals from WCDMA front end block 112, and a 3:1 virtual port 122 is inserted between input port IN7 and the WCDMA PCS, WCDMA IMT and WCDMA 850 diversity signals from WCDMA receive front end block 118. Virtual port 120 can selectively pass one of the WCDMA PCS or WCDMA IMT signals to input port IN6, which effectively frees input port IN7 for use by virtual port 122. Virtual port 122 can selectively pass one of the three received WCDMA signals to input port IN7 in receive diversity operation. For example, if virtual port 120 passes the primary WCDMA IMT signal received from WCDMA front end block 112 to input port IN6, then virtual port is correspondingly controlled to pass the secondary WCDMA IMT signal received from WCDMA receive front end block 118 to input port IN7.

However, according to another embodiment of the invention, the input ports of RF transceiver 104 are preferably wideband inputs, similar to those described in commonly owned U.S. patent application Ser. No. 11/297,335 filed on Dec. 9, 2005, the contents of which are entirely incorporated by reference. Therefore, two or more input signals each at different frequencies can be received by the wideband input, provided they are within the operating frequency range of the wideband input. Accordingly, input port IN7 is also preferably a wideband input and the correct frequency selectivity for receiving any one of the three WCDMA signals.

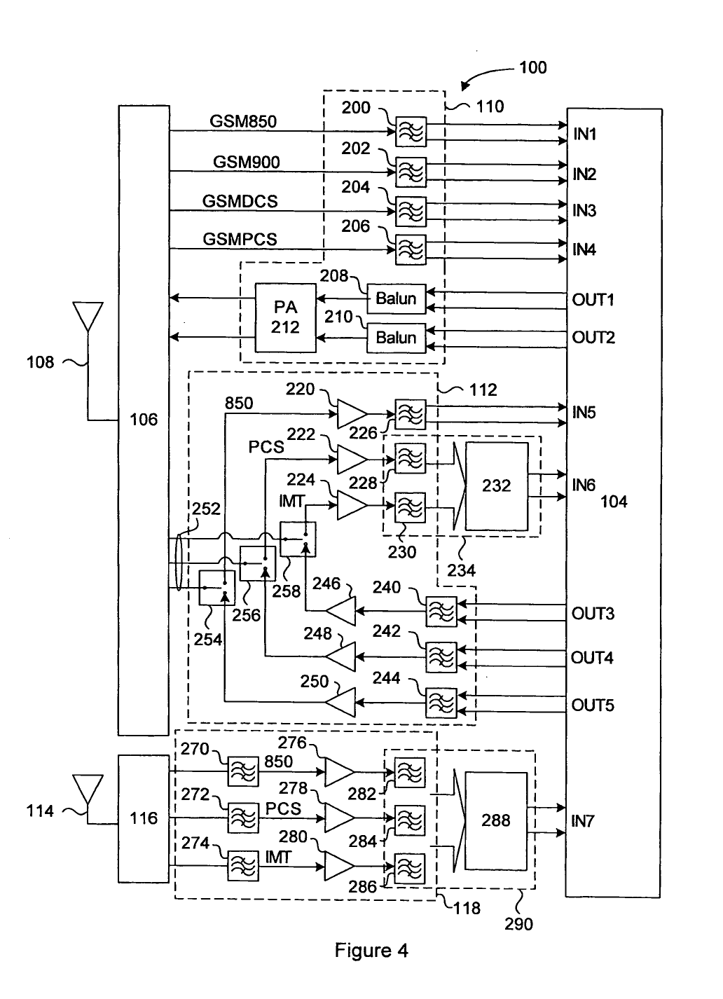

FIG. 4 is an example embodiment of the present invention. More specifically, the wireless device of FIG. 4 shows some implementation details of circuit blocks 110, 112 and 118 of wireless device 100 shown in FIG. 3. The same numbered blocks in FIG. 4 correspond to those previously described in FIG. 3. It should be noted that the digital base-band processor 102 is not shown in order to simplify the schematic. Following will be a description of circuit blocks 110, 112 and 118.

GSM/EDGE front-end block 110 includes a receive section and a transmit section. The receive section includes four receive SAW filters 200, 202, 204 and 206, for receiving the GSM 850, GSM 900, GSM DCS and GSM PCS signals respectively from antenna switch 106. Each SAW filter provides a band-selection and differential output corresponding to its single ended input signal, which are coupled to input ports IN1, IN2, IN3 and IN4. The transmit section includes a pair of baluns 208 and 210, and a quad-band GSM/EDGE power amplifier (PA) module 212. Balun 208 receives a differential output signal from output port OUT1 and generates a corresponding single-ended output, while balun 210 receives a differential output signal from output port OUT2 and generates its own corresponding single-ended output. PA module 212 amplifies the signals from baluns 208 and 210 and provides the amplified signals to antenna switch 106. GSM/EDGE front end block 110 is a standard configuration that is known in the art. In fact, antenna switch 106 and SAW filters 200, 202, 204 and 206 can be purchased as an integrated package for integration/assembly into wireless device 100.

WCDMA front-end block 112 also has a receive section and a transmit section. The receive section includes low noise amplifiers (LNA) 220, 222 and 224 having singled-ended outputs coupled to filter means, implemented as SAW filters 226, 228 and 230. LNA's 220, 222 and 224 receive WCDMA 850, WCDMA PCS and WCDMA IMT signals from antenna switch 106. SAW filter 226 is shown as providing differential signals to input port IN5, however, SAW filters 228 and 230 are shown to provide either differential or single-ended signals to virtual port 232. Virtual port 232 passes one of the WCDMA PCS and WCDMA IMT signals in differential format, to input port IN6. As will be shown later, the configuration of the signal interface circuit 234 consisting of SAW filters 228 and 230 and virtual port 232, can be implemented in different ways depending on the desired format of the input signal (ie. Single-ended or differential). Virtual port 232 is presently shown as a separate component from WCDMA front end block 112, but can easily be integrated as part of WCDMA front end block 112. It is noted that LNA's 220, 222 and 224 and SAW filters 226, 228 and 230 are available

The transmit section includes SAW filters 240, 242 and 244 receiving differential signals from output ports OUT3, OUT4 and OUT5 respectively, each providing single-ended outputs to corresponding power amplifiers 246, 248 and 250. In the present example, power amplifier 246 provides the WCDMA IMT signal, power amplifier 248 provides the WCDMA PCS signal, and power amplifier 250 provides the WCDMA 850 signal. The input section and the output section of WCDMA front end block 112 share a set of three bi-directional lines 252 via duplexers 254, 256 and 258, which provide isolation and filtering. Each of the three bidirectional lines 252 are connected to antenna switch 106 for receiving/providing the WCDMA signals.

Now a description of the receive diversity signal path follows. First, it is noted that input port IN7 has been illustrated near the bottom of RF transceiver 104 instead of between IN6 and OUT3 as previously illustrated in FIG. 3. WCDMA receive front end block 118 includes SAW filters 270, 272 and 274, which perform corresponding functions as duplexers 254, 256, and 258 to provide similar isolation and filtering, receiving single-ended signals from SP3T antenna switch 116, each SAW providing single-ended outputs to corresponding low noise amplifiers 276, 278 and 280. The low noise amplifiers 276, 278 and 280 provide single-ended outputs to corresponding filter means, implemented as SAW filters 282, 284 and 286. SAW filters 282, 284 and 286 are shown to provide either differential or single-ended signals to virtual port 288. These filters may not be necessary in applications where the isolation between antenna 108 and antenna 114 isolation is over 10 dB. Virtual port 288 passes one of the WCDMA 850, WCDMA PCS and WCDMA IMT signals in differential format, to input port IN7. As will be shown later, the configuration of the signal interface circuit 290 consisting of SAW filters 282, 284 and 286 and virtual port 288, can be implemented in different ways depending on the desired format of the input signal (ie. Single-ended or differential).

In WCDMA receive diversity operation, duplexers 254, 256 and 258 are switched to couple bi-directional lines 252 to LNA's 220, 222 and 224, and antenna switch 106 will couple antenna 108 to one of the LNA's 220, 222 and 224, depending on which WCDMA signal standard is being used. Those of skill in the art will understand that the appropriate switching is controlled by the base-band processor. If the signal is a WCDMA PCS signal, then virtual port 232 will be configured to pass the WCDMA PCS signal from SAW filter 228 to input port IN6. Concurrently, antenna switch 116 will couple secondary antenna 114 to one of the LNA's 276, 278 and 280 depending on which WCDMA signal standard is being used. In the present example where the signal is a WCDMA PCS signal, secondary antenna 114 will be coupled to LNA 278 via preselector 272. Accordingly, virtual port 288 will pass the WCDMA PCS signal provided by SAW filter 284 to input port IN7.

Virtual ports 232 and 288 perform the same function, that is, they both perform a switching operation to pass one of several input signals to one output. The main functional difference is that virtual port 232 performs a one of two selection while virtual port performs a one of three selection.

Therefore, due to the effective input port expandability of RF transceiver 104 provided by virtual ports 232 and 288, no additional WCDMA receiver is required. The diversity input signal path can now be provided directly to the RF transceiver 104. This provides two major advantages. First, the board space cost and component cost for the wireless device 100 is reduced, since virtual port components will cost much less and occupy less board area than a dedicated receiver chip. Second, the virtual ports allow the same RF transceiver to be used for diversity and non-diversity implementations of wireless devices. Therefore, the RF transceiver manufacturer can realize the benefits of economies of scale when the same chip can be used in a multiplicity of wireless device designs.

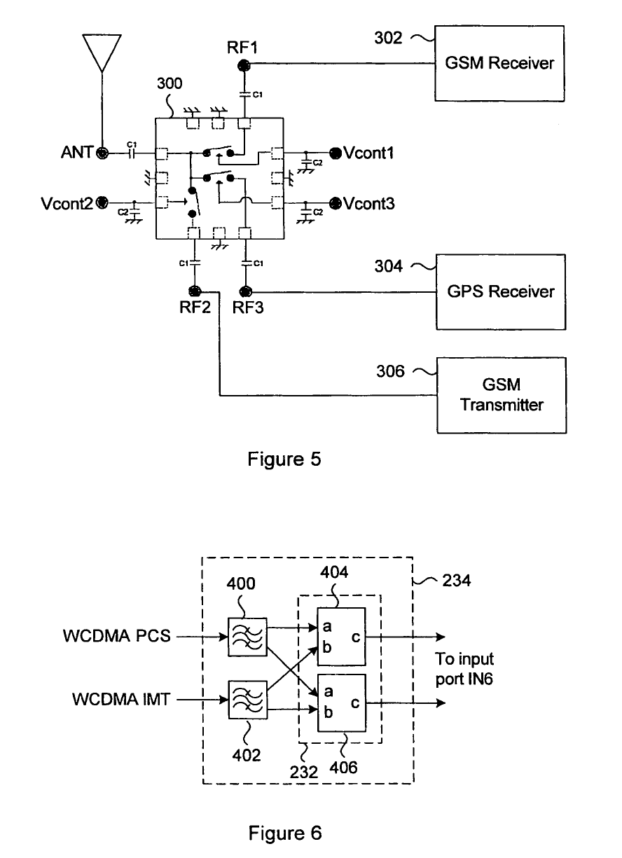

According to one embodiment of the present invention, virtual ports 232 and 288 can be implemented with standard RF switches. RF switches are exclusively used for electrically coupling an antenna to one of several different input/output signal paths. In fact, antenna switches 106 and 116 are standard RF switches which differ only in that switch 106 provides a one of nine selection while switch 116 provides a one of three selection. RF switches are specifically designed for antenna switching operation, as there are electrical parameters which must be carefully considered for RF switching applications. For example, in applications where both WiFi and Bluetooth connectivity is desired, isolation between ports can be between 18 dB to 35 dB. FIG. 5 is a block diagram illustrating a typical application of a commercially available RF switch.

FIG. 5 shows a standard SP3T RF switch used in a typical transmit/receive antenna switching application. By example, the presently shown RF switch is manufactured by NEC under the part number uPG2150T5L. RF switch uPG2150T5L, referred to with reference number 300, has three single-ended signal ports labeled RF1, RF2 and RF3. Each port can be selectively coupled to the antenna port ANT via respective switch circuits. Three control ports Vcont1, Vcont2 and Vcont3 are provided for controlling the switches connected to ports RF1, RF2 and RF3 respectively. The control voltages can be provided by the digital base-band processor. Connected to ports RF1, RF2 and RF3 are GSM receiver 302, GPS receiver 304 and GSM transmitter 306. Hence during operation, only one of the single-ended signal ports is coupled to the antenna port.

It is clear from the uPG2150T5L data sheet that such RF switches are designed and intended for antenna switching purposes only, since the stated electrical requirements are tailored to accommodate such applications. In particular, these switches are intended to be used in antenna applications incorporating the transmit path, where they are designed to handle signals of large power (˜30 dBm). Hence using such switches elsewhere in a wireless device would not be apparent to persons skilled in the art. Furthermore, the commercially available RF switches such as the NEC uPG2150T5L SP3T RF switch, are configured for passing single-ended signals, and not the differential signals received and provided by the RF transceiver. Hence the RF switches are inherently incompatible with the RF transceiver. However, according to the embodiments of the invention, such commercially available RF switches can be used to implement the previously described virtual ports. Also, in the embodiments of the present invention, the RF switches are used in the receive path only, where the power handling requirements are not stringent (<0 dBm).

FIG. 6 is a block diagram of signal interface circuit 234 in FIG. 4, illustrating an implementation example of virtual port 232 according to an embodiment of the invention. Signal interface circuit 234 includes differential output SAW filters 400 and 402 coupled to standard SPDT RF switches 404 and 406. SAW filters 400 and 402 are both of the differential output type, where SAW filter 400 receives the single-ended WCDMA PCS signal and converts it to a differential wireless transmission signal after it is filtered, while SAW filter 402 receives the single-ended WCDMA IMT signal and converts it to a differential wireless transmission signal after it is filtered. Because RF switches 404 and 406 are configured for passing single-ended signals, both are combined to effectively function as a differential RF switch circuit. A description of this combination follows.

RF switch 404 receives one phase of the differential WCDMA PCS signal at port “a” and one phase of the differential WCDMA IMT signal at port “b”. Similarly, RF switch 406 receives the other phase of the differential WCDMA PCS signal at port “a” and the other phase of the differential WCDMA IMT signal at port “b”. Although not shown, RF switches 404 and 406 each have two control inputs for controlling their respective internal switch circuits, for passing the signals from either ports “a” or “b” to port “c”. Port “c” of both RF switches 404 and 406 are coupled to input port IN6, which is differential. Both RF switches 404 and 406 are controlled at the same time such that only ports “a” or “b” from both switches are coupled to their respective port “c”. This can easily be done by having a first common control signal connected to the control ports of both switches for coupling port “a” to port “c”, and a second common control signal connected to the control ports of both switches for coupling port “b” to port “c”.

Since ports “a” of both switches receives the differential WCDMA PCS signal and ports “b” of both switches receives the differential WCDMA IMT signal, concurrent switching by both switches 404 and 406 will effectively provide differential signal switching functionality. RF switches 404 and 406 can be implemented with the NEC uPG2159T5K switch, or the Murata XM0825SR-TL1301_{—}721 SPDT switch. The NEC switch is small at 1 mm by 1 mm in size, thus utilizing very little board space in comparison to a dedicated receiver which can be at least 5 mm by 5 mm. At a cost of about $0.35 per switch unit versus $3 per unit for a wireless receiver, the cost savings are significant.

Since two separate RF switches 404 and 406 are used in the embodiment shown in FIG. 6, one of the practical considerations is signal path matching of the differential signals. Signal path mis-match can occur when one physical conduction line is longer or shorter than the other of the differential pair. In the embodiment of FIG. 6, the conduction line for one of the differential signals from SAW filter 400 to port “a” of RF switch 404 may be shorter than the conduction line for the other of the differential signals from SAW filter 400 to port “a” of RF switch 406. Persons skilled in the art will understand that there are various known techniques for minimizing differential signal path mismatch.

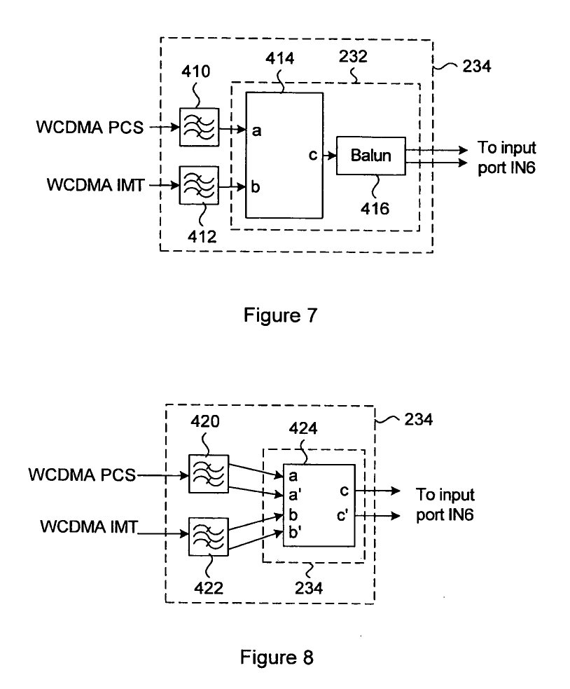

FIG. 7 shows an alternate implementation embodiment of virtual port 232, where differential signal path mismatch can be minimized. In particular, this embodiment performs only single-ended signal switching, unlike the circuit embodiment of FIG. 6 which performs differential signal switching. Signal interface circuit 234 of FIG. 7 includes single-ended output SAW filters 410 and 412, a SPDT RF switch 414, and a wideband balun 416. SAW filter 410 receives the WCDMA PCS signal and provides the filtered single-ended wireless transmission signal output to port “a” of RF switch 414. SAW filter 412 receives the WCDMA IMT signal and provides the filtered single-ended wireless transmission signal output to port “b” of RF switch 414. RF switch 414 can be implemented with the NEC uPG2159T5K switch, or the Murata XM0825SR-TL1301_{—}721 SPDT switch. Port “c” of RF switch 414 is provided to wideband balun 416 for conversion into a differential signal, which is then provided to input port IN6 of the RF transceiver. This implementation is preferably used for two signals that are proximate in frequency, since wideband balun 416 may be frequency limited. The operation of this embodiment is essentially the same as for the embodiment of FIG. 6. However, there is less signal path matching issues for the presently shown embodiment since the single-ended outputs of SAW filters 410 and 412 can be coupled to the ports of RF switch 414 with substantially identical conduction lines.

The example implementation embodiments for virtual port 232 shown in FIG. 6 uses a pair of presently available RF switch circuits for performing differential signal switching. According to another embodiment of the invention shown in FIG. 8, an integrated differential RF switching circuit can be used for providing differential switching functionality. Signal interface circuit 234 of FIG. 8 includes differential SAW filters 420 and 422 and a 2:1 integrated differential switching circuit 424. SAW filter 420 receives the WCDMA PCS signal and provides a differential wireless transmission signal output to ports “a” and “a′” of differential RF switching circuit 424. SAW filter 422 receives the WCDMA INT signal and provides a differential wireless transmission signal output to ports “b” and “b′” of differential RF switching circuit 424. Differential RF switching circuit 424 has the necessary internal switch circuits for coupling one pair of differential input signals to differential output ports “c” and “c′”. The differential outputs from ports “c” and “c′” are then provided to input port IN6 of the RF transceiver.

Therefore, the presently shown embodiment of FIG. 8 is similar to that of FIG. 6, with two significant advantages. An integrated differential RF switch 424 would have its inputs located such that the differential connections (wiring) between SAW filters 420 and 422 can be substantially matched. Also, an integrated differential RF switch would be smaller and thus take up less of the costly board space then two single-ended RF switches.

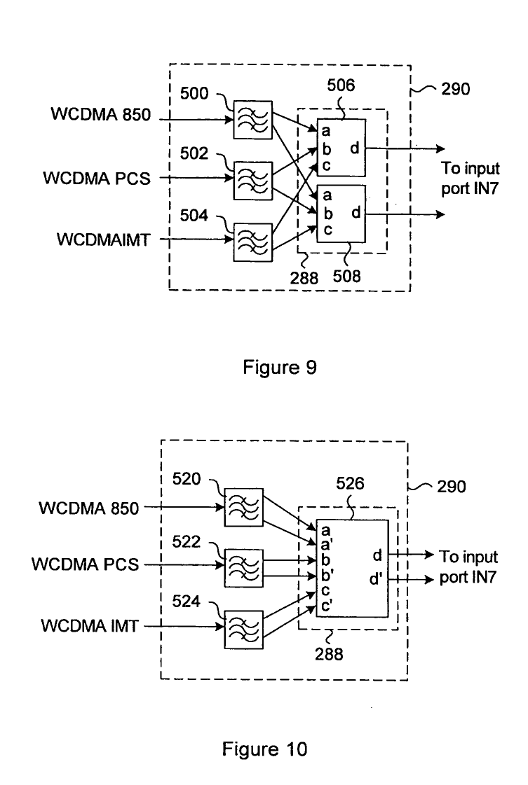

The inventive concept shown in FIGS. 6 to 8 are equally applicable to virtual port 288 shown in FIG. 4. The primary difference between virtual port 288 and virtual port 232 is that virtual port 288 receives three input signals instead of two. FIGS. 9 and 10 illustrate possible implementation examples of virtual port 288 based on the implementation examples shown for virtual port 232.

FIG. 9 is an implementation example of signal interface circuit 290 of FIG. 4 that performs differential signal switching. Signal interface circuit 290 of FIG. 9 includes differential output SAW filters 500, 502 and 504 coupled to standard SP3T RF switches 506 and 508. The differential wireless transmission signal output of SAW filter 500 is coupled to port “a” of RF switches 506 and 508, while similarly the differential wireless transmission signal outputs of SAW filters 502 and 504 are connected to ports “b” and “c” respectively. Output ports “d” from RF switches 506 and 508 are provided to input port IN7 of the RF transceiver. The operation of this circuit is the same as that previously described for the circuit of FIG. 6, except that one of three differential signals can be selectively passed. RF switches 506 and 508 can be implemented with Murata XM0825SF-TL1301_{—}721 or NEC uPG2150T5L parts.

FIG. 10 is an implementation example of virtual port 288 of FIG. 4 that performs differential signal switching using an integrated 3:1 differential RF switch circuit. This embodiment is similar to the embodiment of virtual port 232 shown in FIG. 8. Signal interface circuit 290 of FIG. 10 includes differential SAW filters 520, 522 and 524, a 3:1 integrated differential switching circuit 526. SAW filter 520 receives the WCDMA 850 signal and provides a differential wireless transmission signal output to ports “a” and “a′” of differential RF switching circuit 526. SAW filter 522 receives the WCDMA PCS signal and provides a differential wireless transmission signal output to ports “b” and “b′” of differential RF switching circuit 524. SAW filter 524 receives the WCDMA INT signal and provides a differential wireless transmission signal output to ports “c” and “c′” of differential RF switching circuit 524. Differential RF switching circuit 524 has the necessary internal switch circuits for coupling one pair of differential input signals to differential output ports “ad” and “d′”. The differential outputs from ports “d” and “d′” are then provided to input port IN7 of the RF transceiver. The advantage of using an integrated 3:1 differential RF switch will be the reduced area versus the two-switch implementation of FIG. 9, and the consistent wire interconnection lengths that can be used. Although not shown in FIG. 10, RF switching circuit 526 would have a digital interface for selecting which band is transferred to “d” and “d′”.

Therefore, by employing the virtual port interfaces as described by the embodiments of the present invention, the same RF transceiver chip can be used in multiple wireless device designs, with or without receive diversity. With on-chip receive diversity, receive sensitivity and signal quality during WCDMA receive operations can be enhanced. By example, the receive diversity shown by the present embodiments can enhance HSDPA performance to achieve receive data rates up to 10.2 Mbps.

The presently shown examples of the invention embodiments are illustrated in a tri-band application with diversity. However, the embodiments are equally applicable to dual-band applications with diversity. In a dual-band application with diversity, the primary WCDMA paths would include two (not three) signal standards that are multiplexed to one input port. Correspondingly, the diversity path would include two signal standards. However, if the two standards are close in frequency, then a single RF switch with a balun can be used. This configuration has been illustrated in FIG. 7.

For RF transceivers that do not have a seventh input port (IN7), tri-band implementation with diversity can still be implemented. Taking the example of FIG. 3, the WCDMA 850, PCS and IMT signals can be fed to a 3:1 virtual port having with a single differential output connected to IN5. The possible implementation examples of 3:1 switching have been shown in FIGS. 9 and 10.

While the embodiments of the signal interface circuits are used in a receive diversity application, they can also be used for non-diversity applications, where the RF transceiver does not have sufficient physical input ports for receiving all the types of transmission signals that can be received.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A signal interface circuit for a receiving component, comprising:
filter means for receiving a first wireless transmission signal and a second wireless transmission signal, the filter means providing corresponding first and second wireless transmission signal outputs; and,
a switch circuit for receiving the first and the second wireless transmission signal outputs and for providing a differential output signal corresponding to one of the first and second wireless transmission signal outputs.

2. The signal interface circuit of claim 1, wherein the filter means includes
a first differential output SAW filter for receiving the first wireless transmission signal and for providing a first differential output signal corresponding to the first wireless transmission signal output, and,
a second differential output SAW filter for receiving the second wireless transmission signal and for providing a second differential output signal corresponding to the second wireless transmission signal output.

3. The signal interface circuit of claim 2, wherein the switch circuit includes
a first 2:1 RF switch circuit for receiving first phases of the first differential output signal and the second differential output signal, and for selectively passing one of the first phases,
a second 2:1 RF switch circuit for receiving second phases of the first differential output signal and the second differential output signal, and for selectively passing one of the second phases, the differential output signal corresponding to the passed first and second phases.

4. The signal interface circuit of claim 1, wherein the filter means includes
a first single-ended output SAW filter for receiving the first wireless transmission signal and for providing a first single-ended output signal corresponding to the first wireless transmission signal output, and,
a second single-ended output SAW filter for receiving the second wireless transmission signal and for providing a second single-ended output signal corresponding to the second wireless transmission signal output.

5. The signal interface circuit of claim 4, wherein the switch circuit includes
a 2:1 RF switch circuit for receiving the first and the second single-ended output signals and for selectively passing one of the first and the second single-ended output signals to a balun, the balun providing the differential output signal.

6. A multi-standard compliant wireless device for receiving first and second transmission signals, comprising:
a signal interface circuit for receiving the first and the second transmission signals and for selectively passing one of the first and the second transmission signals as a selected input transmission signal; and
an RF transceiver having first and second input ports each configured for receiving either the first or the second transmission signals, the RF transceiver receiving the selected input transmission signal at the first input port.

7. The multi-standard compliant wireless device of claim 6, wherein the first and the second transmission signals are provided by an antenna switch coupled to an antenna.

8. The multi-standard compliant wireless device of claim 7, wherein the signal interface circuit includes
filter means for receiving the first transmission signal and the second transmission signal, the filter means providing corresponding first and second transmission signal outputs; and,
a switch circuit for receiving the first and the second transmission signal outputs and for providing a differential output signal corresponding to one of the first and second transmission signal outputs.

9. The multi-standard compliant wireless device of claim 8, wherein the filter means includes
a first differential output SAW filter for receiving the first transmission signal and for providing a first differential output signal corresponding to the first transmission signal output, and,
a second differential output SAW filter for receiving the second transmission signal and for providing a second differential output signal corresponding to the second transmission signal output.

10. The multi-standard compliant wireless device of claim 9, wherein the switch circuit includes
a first 2:1 RF switch circuit for receiving first phases of the first differential output signal and the second differential output signal, and for selectively passing one of the first phases,
a second 2:1 RF switch circuit for receiving second phases of the first differential output signal and the second differential output signal, and for selectively passing one of the second phases, the differential output signal corresponding to the passed first and second phases.

11. The multi-standard compliant wireless device of claim 8, wherein the filter means includes
first single-ended output SAW filter for receiving the first transmission signal and for providing a first single-ended output signal corresponding to the first transmission signal output, and,
a second single-ended output SAW filter for receiving the second transmission signal and for providing a second single-ended output signal corresponding to the second transmission signal output.

12. The multi-standard compliant wireless device of claim 11, wherein the switch circuit includes
a 2:1 RF switch circuit for receiving the first and the second single-ended output signals and for selectively passing one of the first and the second single-ended output signals to a balun, the balun providing the differential output signal.

13. The multi-standard compliant wireless device of claim 9, wherein the switch circuit includes a 2:1 integrated differential RF switch circuit for receiving the first differential output signal and the second differential output signal, the differential RF switch circuit selectively passing one of the first differential output signal and the second differential output signal as the differential output signal.

14. The multi-standard compliant wireless device of claim 6, further including a receive diversity circuit for providing a receive diversity signal to the second input port.

15. The multi-standard compliant wireless device of claim 14, wherein the receive diversity circuit includes a second signal interface circuit for receiving a first diversity signal and a second diversity signal, and for selectively passing one of the first diversity signal and the second diversity signal as the receive diversity signal.

16. The multi-standard compliant wireless device of claim 15, wherein the receive diversity circuit includes a second antenna switch coupled to a second antenna for providing the first diversity signal and the second diversity signal.

17. The multi-standard compliant wireless device of claim 15, wherein the second signal interface circuit includes
filter means for receiving the first diversity signal and the second diversity signal, the filter means providing corresponding first and second diversity signal outputs; and,
a switch circuit for receiving the first and the second diversity signal outputs and for providing the receive diversity signal corresponding to one of the first and second diversity signal outputs.

18. The multi-standard compliant wireless device of claim 17, wherein the filter means includes
first differential output SAW filter for receiving the first diversity signal and for providing a first differential output signal corresponding to the first diversity signal output, and,
a second differential output SAW filter for receiving the second diversity signal and for providing a second differential output signal corresponding to the second diversity signal output.

19. The multi-standard compliant wireless device of claim 18, wherein the switch circuit includes
a first 2:1 RF switch circuit for receiving first phases of the first differential output signal and the second differential output signal, and for selectively passing one of the first phases,
a second 2:1 RF switch circuit for receiving second phases of the first differential output signal and the second differential output signal, and for selectively passing one of the second phases, the differential output signal corresponding to the passed first and second phases.

20. The multi-standard compliant wireless device of claim 17, wherein the filter means includes
a first single-ended output SAW filter for receiving the first diversity signal and for providing a first single-ended output signal corresponding to the first diversity signal output, and,
a second single-ended output SAW filter for receiving the second diversity signal and for providing a second single-ended output signal corresponding to the second diversity signal output.

21. The multi-standard compliant wireless device of claim 20, wherein the switch circuit includes
a 2:1 RF switch circuit for receiving the first and the second single-ended output signals and for selectively passing one of the first and the second single-ended output signals to a balun, the balun providing the differential output signal.

22. The multi-standard compliant wireless device of claim 18, wherein the switch circuit includes a 2:1 integrated differential RF switch circuit for receiving the first differential output signal and the second differential output signal, the differential RF switch circuit selectively passing one of the first differential output signal and the second differential output signal as the receive diversity signal.

23. The multi-standard compliant wireless device of claim 15, wherein the second signal interface circuit receives a third diversity signal, and selectively passes one of the first diversity signal, the second diversity signal and the third diversity signal.

24. The multi-standard compliant wireless device of claim 23, wherein the filter means includes
a first differential output SAW filter for receiving the first diversity signal and for providing a first differential output signal corresponding to the first diversity signal output,
a second differential output SAW filter for receiving the second diversity signal and for providing a second differential output signal corresponding to the second diversity signal output, and
a third differential output SAW filter for receiving the third diversity signal and for providing a third differential output signal.

25. The multi-standard compliant wireless device of claim 24, wherein the switch circuit includes a 3:1 integrated differential RF switch circuit for receiving the first differential output signal, the second differential output signal and the third differential output signal, the 3:1 integrated differential RF switch circuit selectively passing one of the first differential output signal, the second differential output signal and the third differential output signal as the receive diversity signal.
